(19) United States
(12) Patent Application Publication
(10) Pub. No.: US 2024/0426255 A1
(43) Pub. Date: Dec. 26, 2024

(54) FUEL INJECTOR CALIBRATION AND CONTROL

(71) Applicant: Cummins Inc., Columbus, IN (US)

(72) Inventor: Donald J. Benson, Columbus, IN (US)

(21) Appl. No.: 18/696,082

(22) PCT Filed: Sep. 22, 2022
(86) PCT No.: PCT/US2022/076826

§ 371 Date: Mar. 27, 2024

Related U.S. Application Data
(60) Provisional application No. 63/262,042, filed on Oct. 4, 2021.

(51) Int. Cl. F02D 41/24; F02D 41/22

(52) U.S. Cl. CPC F02D 41/2467; F02D 2041/224; F02D 2200/0602

(57) ABSTRACT

A method includes operating a fuel injector to perform a fuel injection, determining an estimate of the actual injected quantity of the fuel injection, determining a change in a commanded on time to achieve an injected quantity relative to the commanded on time required to initiate injection of the injector in response to the estimate of the actual injected quantity and a commanded injection quantity, and determining an injector opening rate shape slope estimate for the injector in response to the commanded on time required to initiate injection. The method may further include one or more of outputting a diagnostic or prognostic of the fuel injector, adjusting an injection control parameter, or adjusting an injector monitoring operation in response to the injector opening rate shape slope estimate.

### CROSS-REFERENCE

This application claims priority to and the benefit of International Patent Application No. PCT/US22/76826, filed Sep. 22, 2022, which claims priority to and the benefit of U.S. Application No. 63/262,042 filed Oct. 4, 2021, which are hereby incorporated by reference in their entirety.

### TECHNICAL FIELD

The present application relates to fuel injector calibration and control apparatuses, methods, and systems and more particularly, but not exclusively to such apparatuses, methods, and systems using injector opening rate shape slope.

### BACKGROUND

The performance of the combustion event in an engine depends on many factors including the injector opening rate shape slope of an injection event. A robust, accurate, and computationally efficient method for estimating the injector opening rate shape slope for each injector during engine operation is desirable.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include unique fuel injector calibration and control apparatuses. Some embodiments include unique fuel injector calibration and control methods. Some embodiments include unique fuel injector calibration and control systems. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example engine system including an example fuel injection system.

FIG. 2 is a schematic diagram illustrating certain aspects of example engine system controls.

FIG. 3 is a graph illustrating injection rate as a function of time from an injector opening command for an example injection command and a resulting example injection rate shape.

FIG. 4 is a graph illustrating an optimal injected quantity as a function of the pressure for a nominal injector.

FIG. 5 is a graph illustrating a change in commanded on time for the optimal injected quantity as a function of the pressure for a nominal injector.

FIG. 6 is a graph illustrating injected quantity as a function of commanded on time for a nominal injector at a plurality of rail pressures.

FIG. 6A is a graph illustrating injected quantity as a function of commanded on time for an injector with a low opening rate shape slope at a plurality of rail pressures.

FIG. 6B is a graph illustrating injected quantity as a function of commanded on time for an injector with a high opening rate shape slope at a plurality of rail pressures.

FIG. 7 is a graph illustrating injector opening rate shape slope as a function of injector rail pressure for a nominal injector.

FIG. 8 is a graph illustrating the ratio in the change in injector opening slope to the change in ΔT_{BF} as a function of injector rail pressure for a nominal injector.

FIG. 9 is a graph illustrating the ratio of ΔT_{BF}_{_{Ind}} to ΔT_{BF}_{_{Nom}} as a function of injector rail pressure for a nominal injector.

### DETAILED DESCRIPTION OF EXAMPLE EMBODIMENTS

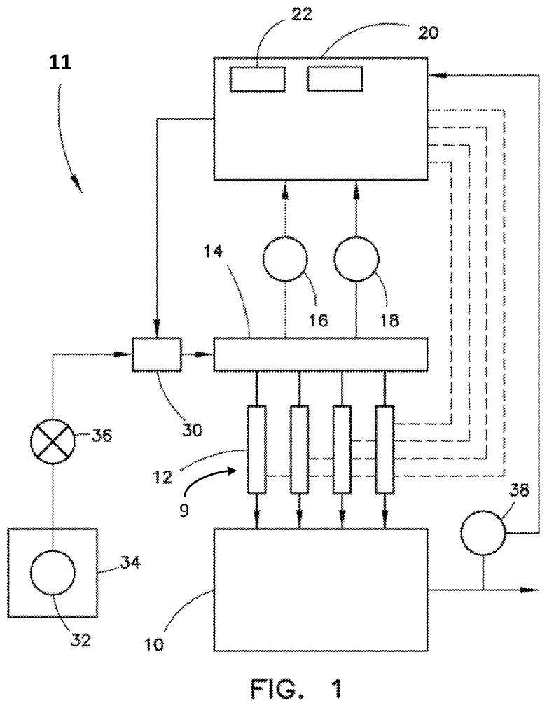

With reference to FIG. 1, there is illustrated a system 11 comprising an engine 10 including a fuel injection system 9 including one or more fuel injectors 12. The engine 10 may be an internal combustion engine, including but not limited to a compression-ignition engine, using diesel or other suitable fuel, or a spark-ignition engine, using gasoline, natural gas, or other suitable fuels. Engine 10 may have one or more combustion cylinders (not depicted) to generate mechanical power from the combustion of a fuel. The fuel injectors 12 are in fluid communication with respective combustion cylinders of the engine 10 and are structured to introduce the fuel into respective combustion cylinders. Though four fuel injectors 12 are depicted in FIG. 1, engine 10 may include fewer or greater numbers of fuel injectors 12. In certain embodiments, engine 10 may include one fuel injector 12 for each cylinder. In the illustrated embodiment, the fuel injection system 9 is configured and provided as a high-pressure common-rail fuel injection system wherein the fuel injectors 12 are in fluid communication with a common fuel rail 14, which supplies fuel at relatively high pressure to each fuel injector 12.

Fuel may be supplied to the common fuel rail 14 by a high-pressure pump 30. In certain embodiments, the high-pressure pump may be fed by a relatively low-pressure fuel circuit including a booster pump 32, which may be immersed in a tank 34 containing the fuel. A fuel regulator 36 may control the flow of fuel from tank 34 to the high-pressure pump 30.

System 11 further includes an electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 may include one or more modules 22 configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the system 11. For example, the sensors may include a pressure sensor 16 and a temperature sensor 18. The pressure sensor 16 is in communication with the common fuel rail 14 and structured to communicate a measurement of the pressure within the common fuel rail 14 to the ECS 20. The temperature sensor 18 is in communication with the common fuel rail 14 and structured to communicate a measurement of the temperature within the common fuel rail 14 to the ECS 20. In at least one embodiment, system 11 may include an oxygen sensor 38 (e.g., a lambda sensor) in communication with the ECS 20 and structured to determine characteristics of exhaust gases generated and expelled by the engine 10. In one example, oxygen sensor 38 may determine the concentration of oxygen in the exhaust gases as a proxy for the concentration of regulated emissions.

As will be appreciated by the description that follows, the techniques described herein relating to fuel injector or fuel injection parameters can be implemented in ECS 20, which may include one or more controllers for controlling different aspects of the system 11. In one form the ECS 20 comprises one or more electronic control units (ECU) such as an engine control unit or engine control module. The ECS 20 may be comprised of digital circuitry, analog circuitry, or a hybrid combination of both of these types. Also, the ECS 20 may be programmable, an integrated state machine, or a hybrid combination thereof. The ECS 20 may include one or more Arithmetic Logic Units (ALUs), Central Processing Units (CPUs), memories, limiters, conditioners, filters, format converters, or the like which are not shown to preserve clarity. In one form, the ECS 20 is of a programmable variety that executes algorithms and processes data in accordance with operating logic that is defined by programming instructions (such as software or firmware). Alternatively or additionally, operating logic for the ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 11. As used herein, the term sensors may include any suitable hardware and/or software used to sense or estimate any engine system parameter and/or various combinations of such parameters either directly or indirectly.

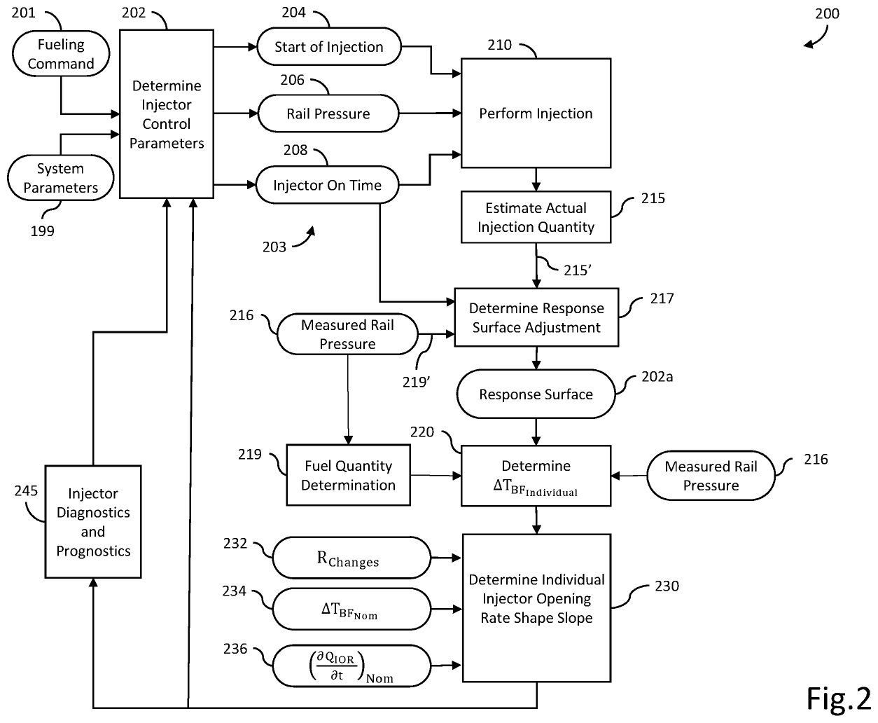

With reference to FIG. 2, there are illustrated example controls 200 which may be implemented in and executed by an electronic controller of an engine system, such as ECS 20 of engine system 11. It shall be appreciated that controls 200 may be implemented in whole or in part by instructions which are stored in one or more non-transitory memory media and are readable and executable by one or more electronic controllers or processors to perform the operations of controls 200.

Operator 202 determines a plurality of injector control parameters 203 in response to a fueling command 201 which indicates a commanded fueling quantity and a commanded fucling timing (e.g., an amount of fueling that is requested by an engine controller and a timing or degree in an engine cycle for delivery of the fueling). In the illustrated example, the plurality of injector control parameters 203 includes a start of injection 204, a rail pressure 206, and an injector on time 208. In other examples, the plurality of control parameters 203 may include additional and/or alternative injector control parameters. The plurality of control parameters 203 are provided to injection operator 210 which controls a fuel injector to perform an injection in response to the plurality of injector control parameters 203.

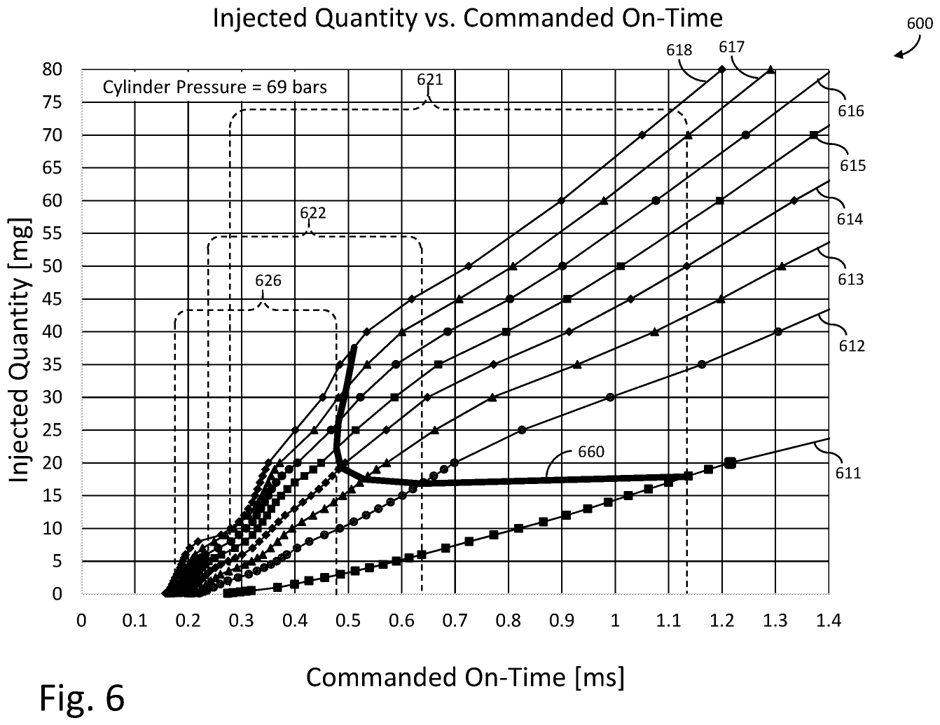

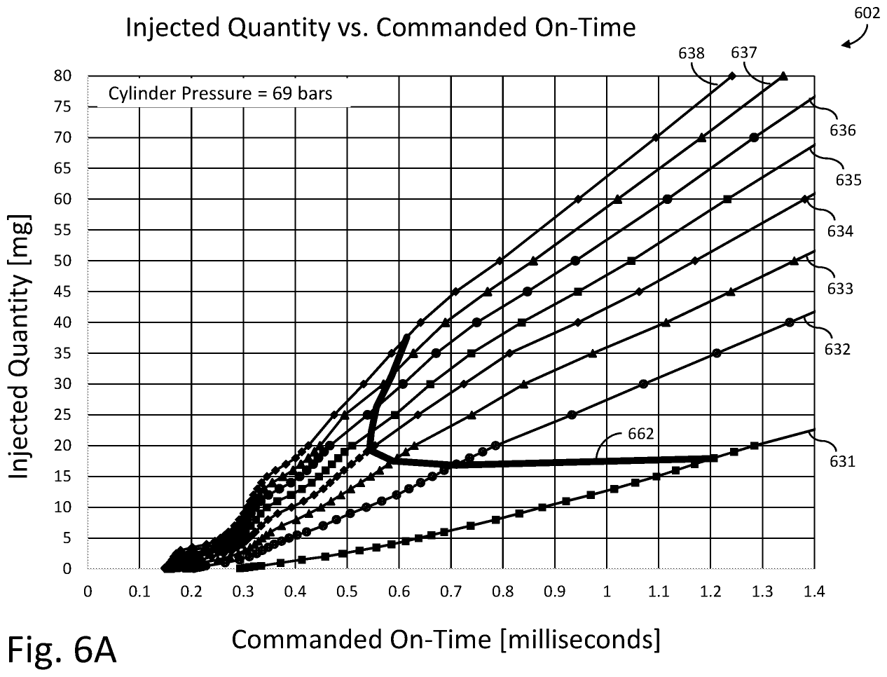

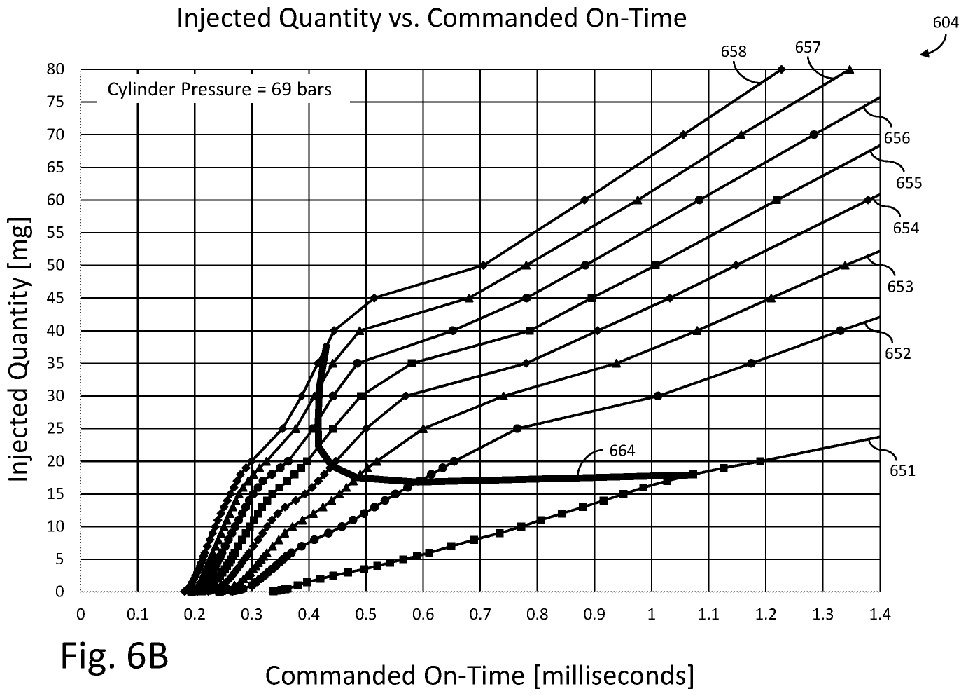

Operator 202 may determine the plurality of injector control parameters 203 using one or more response surfaces which may be implemented by one or more lookup tables, one or more equations, one or more dynamic calculations, or combinations thereof. Operator 202 may use a response surface to determine a commanded on time that will provide a commanded or requested amount of fueling at a given rail pressure. As further described below, FIGS. 6, 6A, and 6B illustrate examples of the relationship between injected quantity, rail pressure, and commanded on time which may be defined or provided by a response surface. For example, in response to a command or request for 25 mg of fuel, operator 202 may determine a commanded on time of 0.6 milliseconds for a rail pressure corresponding to curve 653 using the response surface information illustrated in FIG. 6B. When an engine is commissioned or recommissioned, the one or more response surfaces may initially be configured with initial default settings for a nominal injector (e.g., a baseline nominal injector which typically agrees with the state of the injector with which the system was nominally calibrated) which may be subsequently adjusted as described below.

Operator 202 may also utilize injector opening rate shape slope information in determining the plurality of injector control parameters 203. Operator 202 may utilize injector opening rate shape slope information in determining a start of injection timing, a rail pressure, or both. For example, operator 202 may advance a start of injection timing relative to a default or nominal value in response to an injector opening rate shape slope that is less than that of a default or nominal injector. The lesser opening rate shape slope characterizes an injector that is opening at a slower rate than a nominal or default injector which has the effect of delaying the time at which a defined portion of the total fueling of injection has been delivered. The defined portion may be, for example, the centroid of an injection quantity or injection rate curve, or other geometrically or mathematically defined portions of an injection quantity or injection rate. Thus, operator 202 may determine an advanced or earlier start of injection that has the effect of moving or repositioning that defined portion of the total fueling (e.g., the centroid) to more closely match the commanded fueling timing associated with fueling command 201.

Operator 202 may delay or retard a start of injection timing relative to a default or nominal value in response to an injector opening rate shape slope that is greater than that of a default or nominal injector. The greater opening rate shape slope characterizes an injector that is opening at a faster rate than a nominal or default injector which has the effect of advancing the time at which a defined portion of the total fueling of an injection is been delivered. Thus, operator 202 may determine a delayed or retarded start of injection that has the effect of moving or repositioning that defined portion of the total fueling (e.g., the centroid) to more closely match the commanded fueling timing associated with fueling command 201.

Operator 202 may additionally or alternatively adjust an injection pressure (e.g., an injector rail pressure or individual injector pressures) in response to an injector opening rate shape slope varying from that of a default or nominal injector. For example, in response to opening rate shape slopes for multiple or all injectors of a system characterizing injectors that are opening at a slower rate than a nominal or default injector, operator 202 may increase a rail pressure which has the effect of advancing the time at which a defined portion (e.g., the centroid) of the total fueling of an injection is been delivered. Similarly, in response to opening rate shape slopes for multiple or all injectors of a system characterizing injectors that are opening at a faster rate than a nominal or default injector, operator 202 may decrease a rail pressure which has the effect of delaying or retarding the time at which a defined portion (e.g., the centroid) of the total fueling of an injection is been delivered.

It shall be appreciated that the fueling command 201 may include commands for multiple fueling quantities or pulses within a net composite fueling command to optimize the net fueling distribution for purposes such as reducing undesired emissions, reducing audible noise, and optimizing fuel economy. When multiple pulses are commanded as part of a net composite fueling command or injection string, the timing separation of these injection pulses is included in the fueling command 201. Operator 202 may determine the plurality of injector control parameters 203 further in response to other system parameters 199 such as the difference between the desired rail pressure and the current measured rail pressure, the fuel type, temperature state of the engine and its subsystems, the ambient temperature, the altitude and the operating state of the engine's aftertreatment system.

Operator 215 monitors the injection operations performed in response to injection operator 210 and determines an estimate of an actual injected quantity 215′ (i.e., the quantity of fuel actually injected during an injection event, sometimes also referred to as an injection quantity). Operator 215 may determine the estimate of the actual injected quantity 215′ using a number of techniques such as by monitoring changes in rail pressure or other injection system pressures or using other techniques as will occur to one of skill in the art with the benefit and insight of the present disclosure, for example, monitoring the change in the pressure within cach injector, or using a sensor which detects the contact between an injector nozzle and plunger in order to detect the start and end of each injection event. In some embodiments, operator 215 may monitor rail pressure during an injection event (e.g., from at least the commanded on time to at least the end of an injection event) to determine an estimate of the actual injected quantity over the measurement time.

Operator 217 receives the estimate of the actual injected quantity 215′, the commanded injector on time 208 associated with fueling command 201, and a measured rail pressure 216. Operator 217 uses the received parameters 208, 215′, and 216 to determine an adjustment to a response surface for an injector, also referred to herein as a response surface adjustment. The response surface defines the interaction or interrelationship of parameters 208, 215′, and 216 for an injector during the operation of the engine. The response surface adjustment may be utilized to modify or update response surface parameters 202a which, in turn, may be utilized by operator 202 as described above. The response surface adjustment determined by operator 217 may be configured to minimize or mitigate the magnitude of the difference between the commanded injected quantity and the actual injected quantity at all operating states in response to a normal fueling drift and variation of the injected quantity over the operational lifetime of the system. Operator 217 may perform this determination for each injector individually and may repeat this determination in response to each estimated actual injected quantity received from operator 215. The response surface parameters 202a may be provided in a number of forms, for example, as one or more equations, graphs, maps, tables, or other data structures comprising information such as illustrated and described below in connection FIGS. 6, 6A, and 6B. The current response surface provides an expected injected quantity for a given commanded injector on time at a given injector rail pressure and represents a current operating model of a fuel injector.

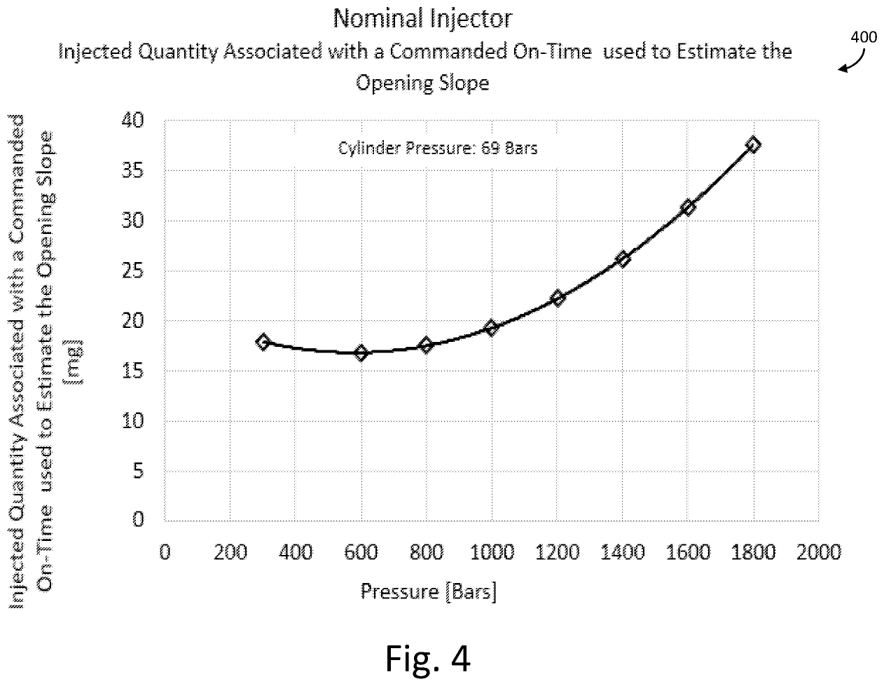

The measured rail pressure 216 is also provided to operator 219 which is configured to determine a fuel quantity in response to the measured rail pressure 216 and provide the determined fuel quantity 219′ to operator 220. Operator 219 may be configured to perform this determination using information indicating a relationship between injection pressure and fuel quantity, for example, information such as that illustrated and described below in connection with graph 400 of FIG. 4. This information may be provided in a number of forms, for example, as one or more equations, graphs, maps, tables, or other data structures comprising information.

Operator 220 receives the modified or updated response surface parameters 202a, the measured rail pressure 216, and the determined fuel quantity 219′. Operator 220 determines a change in the commanded on time for an individual injector needed to achieve an injected quantity for the individual injector (ΔT_{BF}_{_{Ind}}) in response to input parameters 202a, 216, and 219′. Operator 220 may be configured to perform this determination using information indicating a relationship between injector on time and fuel quantity for a given injection pressure, for example, information such as that illustrated and described below in connection with FIG. 6, 6A, and 6B. This information may be provided in a number of forms, for example, as one or more equations, graphs, maps, tables, or other data structures comprising information. For example, operator 220 may use the modified or updated response surface parameters 202a to determine a commanded on time indicated by the point at which a curve defined for an injection pressure corresponding to measured rail pressure 216 has an injected quantity value corresponding to the determined fuel quantity 219′. The change in the commanded on time for an individual injector (ΔT_{BF}_{_{Ind}}) may then be determined from the commanded on time using the relationship described below in connection with Equation 3.

It shall be appreciated that the change in the commanded on time for an individual injector (ΔT_{BF}_{_{Ind}}) is one example of an on time control parameter of an individual injector that may be utilized in connection with determining an injector opening rate shape slope estimate for an individual injector. Some embodiments may utilize a different on time control parameter of an individual injector, for example, the commanded on time associated with an injected quantity for an individual injector (T_{BF}_{_{Ind}}). Thus, while a number of examples herein are described in connection with the change in the commanded on time for an individual injector (ΔT_{BF}_{_{Ind}}), it shall be appreciated that they may also utilize such other on time control parameters of an individual injector.

Operator 230 receives the change in the commanded on time for an individual injector (ΔT_{BF}_{_{Ind}}) and determines an injector opening rate shape slope estimated for an individual injector in accordance with Equation (1):

$${( \frac{\partial {Q}_{IOR}}{\partial t} )}_{Est} = {( \frac{\partial {Q}_{IOR}}{\partial t} )}_{Nom} * [ 1 + ( \frac{Δ {T}_{{BF}_{Ind}}}{Δ {T}_{{BF}_{Nom}}} - 1 ) * {R}_{Changes} ] ,$$

where

$${( \frac{\partial {Q}_{IOR}}{\partial t} )}_{Est}$$

is the injector opening rate shape slope estimate for an individual injector and is determined by operator 230,

$${( \frac{\partial {Q}_{IOR}}{\partial t} )}_{Nom}$$

is ine injector opening rate shape slope for a nominal injector and is received by operator 230 as input 236, ΔT_{BF}_{_{Ind}} is the change in the commanded on time to achieve an injected quantity relative to the commanded on time required to initiate injection for an individual injector and is received by operator 230 as input from operator 220, ΔT_{BF}_{_{Nom}} is the change in the commanded on time to achieve an injected quantity relative to the commanded on time required to initiate injection for a nominal injector and is received by operator 230 as input 234, and R_{Changes} is the ratio in the change in injector opening slope to the change in ΔT_{BF} and is received by operator 230 as input 232.

It shall be appreciated that, in Equation (1), the term ΔT_{BF}_{_{Ind}} is variable and adaptive to a given individual injector while the other terms are fixed and non-adaptive in the control structure and may, for example, be determined as follows. The value of

$${( \frac{\partial {Q}_{IOR}}{\partial t} )}_{Nom}$$

may be determined empirically from testing of a representative group of injectors of a given design or by design characteristic or design simulation for a given nominal injector design. The value of

$${( \frac{\partial {Q}_{IOR}}{\partial t} )}_{Nom}$$

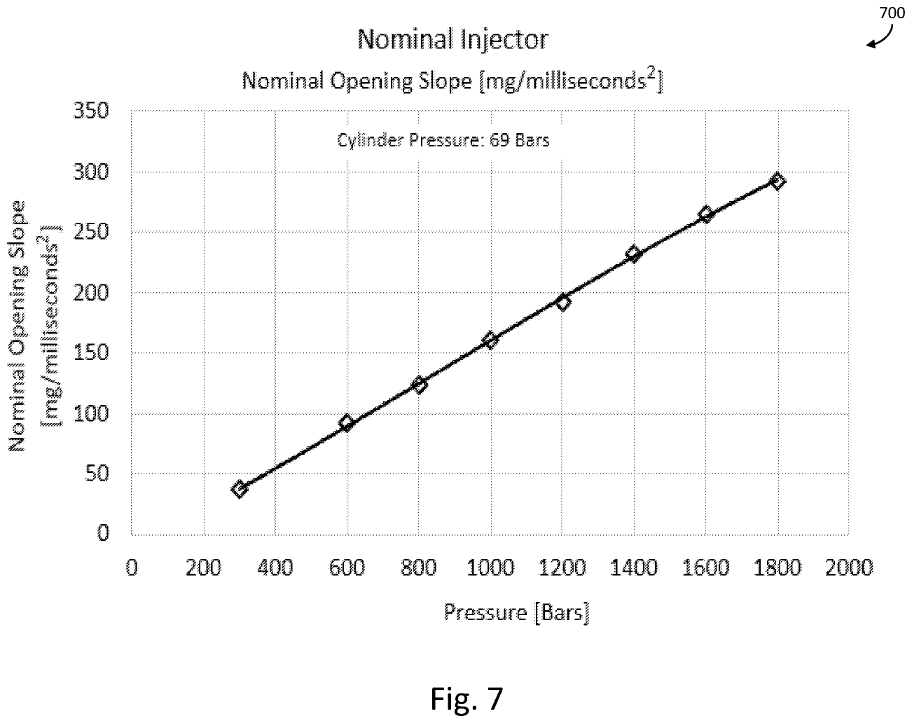

may be provided or set as a variable in controls 200, for example as one or more equations, graphs, maps, tables, or other data structures representing the relationship illustrated in graph 700 of FIG. 7.

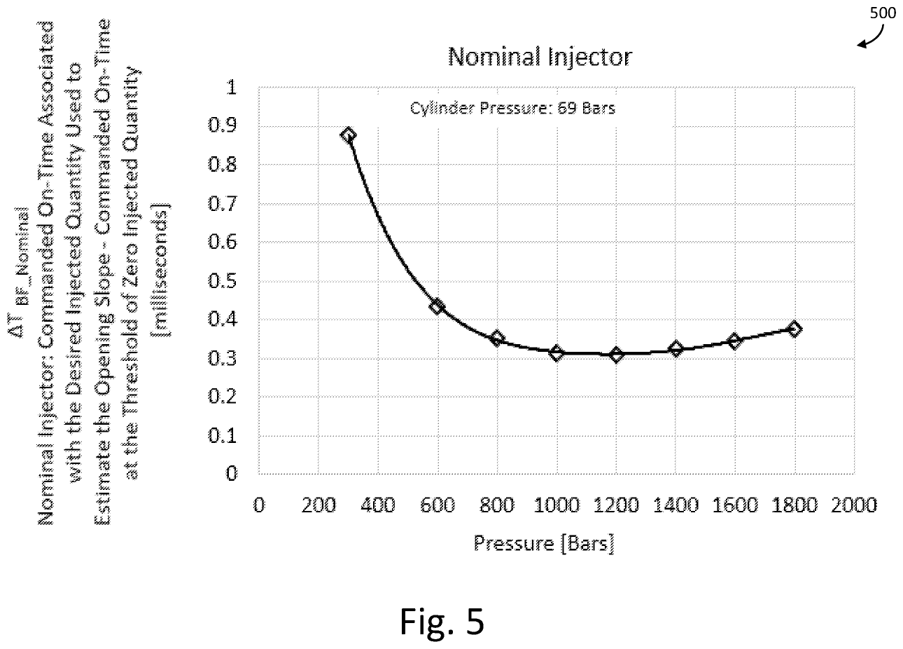

The value of ΔT_{BF}_{_{Nom}} may be determined empirically from testing of a representative group of injectors of a given design or by design characteristic or design simulation for a given nominal injector design. The value of ΔT_{BF}_{_{Nom}} may be and provided or set as a variable in controls 200, for example as one or more equations, graphs, maps, tables, or other data structures representing the relationship illustrated in graph 500 of FIG. 5.

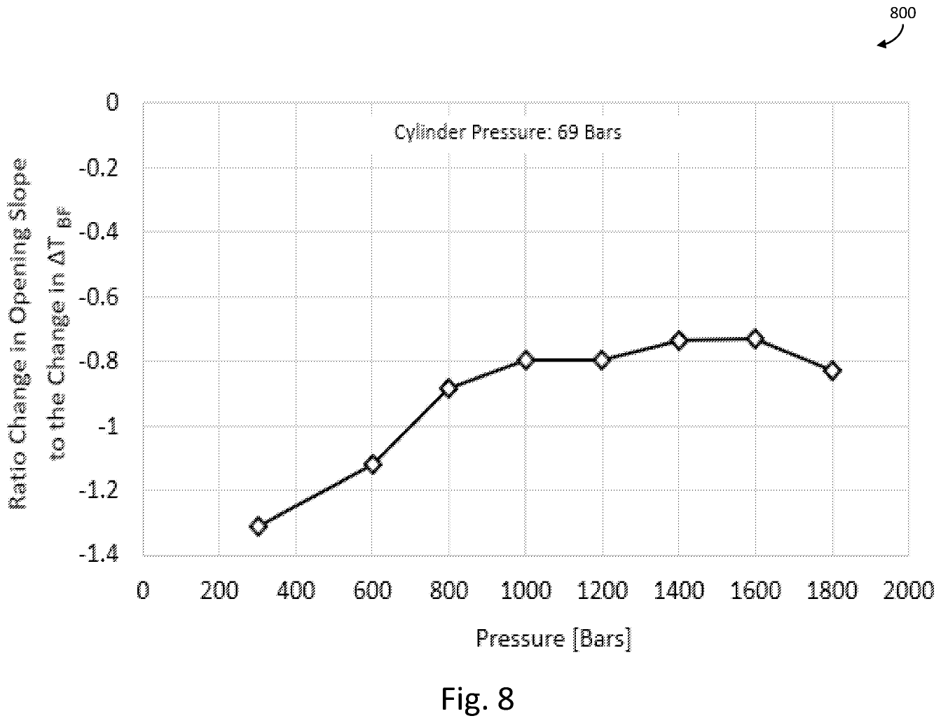

The value of R_{Changes} may be determined empirically from testing of a representative group of injectors of a given design or by design characteristic or design simulation for a given nominal injector design. The value of R_{Changes} may be provided or set as a variable in controls 200, for example as one or more equations, graphs, maps, tables, or other data structure representing the relationship illustrated in graph 1000 of FIG. 8.

The injector opening rate shape slope

$${( \frac{\partial {Q}_{IOR}}{\partial t} )}_{Est}$$

determined by operator 230 is provided to operator 202 which may utilize the injector opening rate shape slope

$${( \frac{\partial {Q}_{IOR}}{\partial t} )}_{Est}$$

in determining the plurality of injector control parameters 203 as described above. The injector opening rate shape slope

$${( \frac{\partial {Q}_{IOR}}{\partial t} )}_{Est}$$

is also providea to operator 245 which may utilize the injector opening rate shape slope

$${( \frac{\partial {Q}_{IOR}}{\partial t} )}_{Est}$$

in performing diagnostics prognostics or may store the information for subsequent use in diagnostics or prognostics. Such diagnostics and prognostics may be based on values or changes in values of opening rate shape slope and may include determining or predicting failure of one or more injectors, determining or predicting a need or time for replacement of one or more injectors, and/or determining or predicting a need or time for service of one or more injectors.

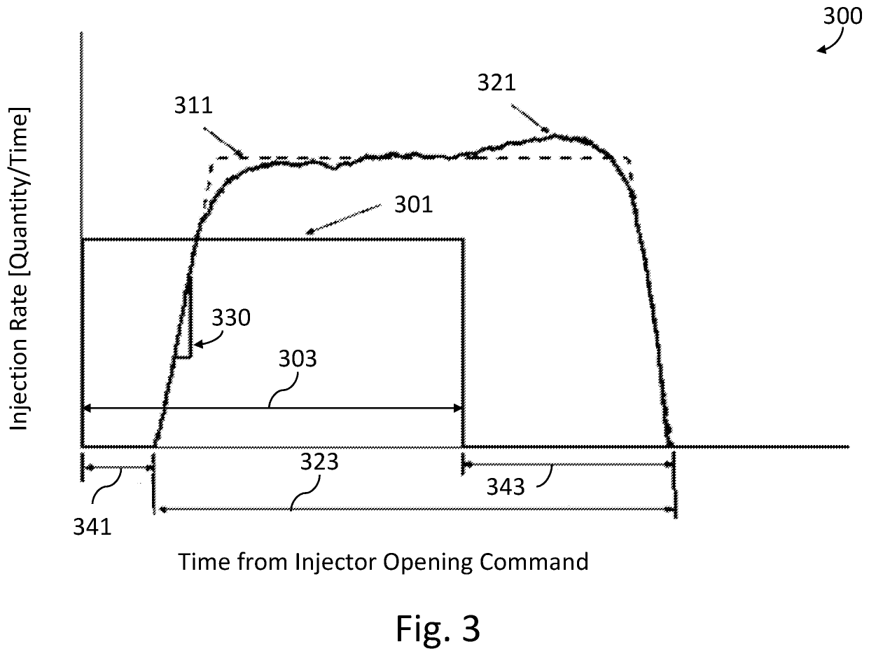

With reference to FIG. 3, there is illustrated a graph 300 having fuel injection rate (quantity/time) on its y-axis and time from an injector opening command on its x-axis. Graph 300 depicts an example injection command 301, a modeled injection fueling rate shape 311, and an actual fueling rate shape 321. The injection command 301 has a commanded injector open duration 303. The actual fueling rate shape 321 is subject to a start of injection delay time 341 and an end of injection delay time 343 which are attributable to delays inherent in the physical response of an injector to a transmitted injector command and/or an applied injector control signal. The modeled injection fueling rate shape 311 exhibits similar delays as it closely matches the variation of the actual fueling rate shape 321 in at least these respects.

The actual fueling rate shape 321 also has an injector opening rate shape slope 330 which is related to the resulting change in the injected quantity for the change in the actual injection duration. Since a change in the actual injection duration is related to the change in the commanded on time duration, the injector opening rate shape slope of an injection event is related to the change in the injected quantity for a change in the commanded on time. After the commencement of the injection event as the rate of injection is increasing, a first section of the injection rate (e.g., a section in the middle 20-80%, 30-70%, or 40-60% of the initial rise of injector opening rate shape curve) may be approximated by the most representative injector opening rate shape slope. Accordingly, this section may be utilized by controls such as controls 200 in determining the injector opening rate shape slope of an individual injector during engine operation. It shall be appreciated that other sections of the injector opening rate shape slope may also be utilized in some embodiments provided that they produce acceptably accurate, precise, and robust results.

There is an optimal injected quantity as a function of the injector operating pressure at which the robustness, accuracy, and precision of the relationship between the change in the commanded on time to the injector and the injector opening rate shape slope is optimal. This optimal injected quantity as a function of the pressure is shown in graph 400 of FIG. 4 for an example embodiment injector. Accordingly, these optimal injected quantities may be utilized by controls such as controls 200. It shall be appreciated that other injected quantities may also be utilized in some embodiments provided that they produce acceptably accurate, precise, and robust results.

For an example nominal injector, the change in the commanded on time needed to achieve a commanded injected quantity may be described and modeled in accordance with Equation (2): ΔT_{BF}_{_{Nom}}=T_{BF}_{_{Nom}}−T_{ZF}_{_{Nom}}, where
ΔT_{BF}_{_{Nom}} is the change in the commanded on time needed to achieve the injected quantity for the nominal injector,
T_{BF}_{_{Nom}} is the commanded on time associated with the injected quantity for the nominal injector, and
T_{ZF}_{_{Nom}} is the commanded on time required to initiate injection (i.e., the minimum commanded on time for any fuel injection to occur or below which no fuel injection occurs) for the nominal injector.

The change in the commanded on time needed to achieve the injected quantity (ΔT_{BF_Nom}) for the example nominal injector as a function of pressure is shown in graph 500 illustrated in FIG. 5 for the injected quantity values shown in graph 400 of FIG. 4. The optimal injected quantities and values of ΔT_{BF}_{_{Nom}} of graph 400 and graph 500. Accordingly, these optimal commanded on times may be utilized by controls such as controls 200. It shall be appreciated that other commanded on times may also be utilized in some embodiments provided that they produce acceptably accurate, precise, and robust results.

With reference to FIG. 6, there is illustrated a graph 600 having injected quantity of fuel (mg) on its y-axis and commanded on time of an injector (ms) on its x-axis. A plurality of curves (611, 612, 613, 614, 615, 616, 617, and 618) depict the relationship between injected quantity and commanded on time for a plurality of different rail pressures (300, 600, 800, 1000, 1200, 1400, 1600, and 1800 bar, respectively). The values of T_{BF}_{_{Nom}}, T_{ZF}_{_{Nom}}, and ΔT_{BF}_{_{Nom}} vary for different rail pressures. Thus, for example, at 300 bars of pressure ΔT_{BF}_{_{Nom}}=0.877 ms as indicated by bracket 621, at 600 bars of pressure ΔT_{BF}_{_{Nom}}=0.436 ms as indicated by bracket 622, and at 1400 bars of pressure ΔT_{BF}_{_{Nom}}=0.323 ms as indicated by bracket 626.

A curve 660 depicts the commanded on times for each of the plurality of curves (611, 612, 613, 614, 615, 616, 617, and 618) that will provide injected quantities corresponding to the optimal injected quantities and values of ΔT_{BF}_{_{Nom}} of graph 400 and graph 500. Thus, curve 660 defines preferred or optimal commanded on times and respective injection quantities that can be utilized in determining an injector opening rate shape slope. It shall be appreciated that injector opening rate shape slopes can be determined at values varying from those of curve 660, provided that the resulting degree of variation from the optimized robustness, accuracy, and precision provide by curve 660 is deemed acceptable for a given embodiment or control purpose.

Individual injectors of a nominal injector design or type may vary in performance from the nominal injector. For an individual injector, the change in the commanded on time needed to achieve a commanded injected quantity may be described and modeled in accordance with Equation (3): ΔT_{BF}_{_{ind}}=T_{BF}_{_{Ind}}−T_{ZF}_{_{ind}}, where
ΔT_{BF}_{_{Ind}} is the change in the commanded on time needed to achieve the injected quantity for the individual injector,
T_{BF}_{_{Ind}} is the commanded on time associated with the injected quantity for the individual injector, and
T_{ZF}_{_{Ind}} is the commanded on time required to initiate injection (i.e., the minimum commanded on time for any fuel injection to occur or below which no fuel injection occurs) for the individual injector.

The change in the commanded on time needed to achieve the injected quantity (ΔT_{BF_Ind}) for the example individual injector as a function of pressure may vary from the change in the commanded on time needed to achieve the injected quantity (ΔT_{BF_Nom}) for the example nominal injector.

For example, FIG. 6A illustrates a graph 602 having injected quantity of fuel (mg) on its y-axis and commanded on time of an injector (ms) on its x-axis for an example injector with a low opening rate shape slope at a plurality of rail pressures. A plurality of curves (631, 632, 633, 634, 635, 636, 637, and 638) depict the relationship between injected quantity and commanded on time for a plurality of different rail pressures (300, 600, 800, 1000, 1200, 1400, 1600, and 1800 bar, respectively) for the example injector with the low opening rate shape slope. The values of T_{BF}_{_{Ind}}, T_{ZF}_{_{Ind}}, and ΔT_{BF}_{_{Ind}} vary for different rail pressures and may also vary from the values of T_{BF}_{_{Nom}}, T_{ZF}_{_{Nom}}, and ΔT_{BF}_{_{Nom}} at the same rail pressures. Thus, for example, at 300 bars of pressure ΔT_{BF}_{_{Ind}}=0.991 ms, at 600 bars of pressure ΔT_{BF}_{_{Ind}}=0.517 ms, and at 1400 bars of pressure ΔT_{BF}_{_{Ind}}=0.392 ms. Thus, it can be seen that the values ΔT_{BF_Ind} for the example injector with a low opening rate shape slope are greater than the values of ΔT_{BF_Nom} at corresponding operating pressures.

A curve 662 depicts the commanded on times for each of the plurality of curves (631, 632, 633, 634, 635, 636, 637, and 638) that will provide injected quantities corresponding to the optimal injected quantities and values generally corresponding of ΔT_{BF}_{_{Nom}} of graph 400 and graph 500. Thus, curve 662 defines preferred or optimal commanded on times and respective injection quantities that can be utilized in determining an injector opening rate shape slope. It shall be appreciated that injector opening rate shape slopes can be determined at values varying from those of curve 662, provided that the resulting degree of variation from the optimized robustness, accuracy, and precision provide by curve 662 is deemed acceptable for a given embodiment or control purpose. It shall be further appreciated that the shape of curve 662 varies from the shape of curve 660 reflecting differences in the operation of the individual injector from the nominal injector.

In a further example, FIG. 6B illustrates a graph 604 having injected quantity of fuel (mg) on its y-axis and commanded on time of an injector (ms) on its x-axis for an example injector with a low opening rate shape slope at a plurality of rail pressures. A plurality of curves (651, 652, 653, 654, 655, 656, 657, and 658) depict the relationship between injected quantity and commanded on time for a plurality of different rail pressures (300, 600, 800, 1000, 1200, 1400, 1600, and 1800 bar, respectively) for the example injector with the low opening rate shape slope. The values of T_{BF}_{_{Ind}}, T_{ZF}_{_{Ind}}, and ΔT_{BF}_{_{Ind}} vary for different rail pressures and may also vary from the values of T_{BF}_{_{Nom}}, T_{ZF}_{_{Nom}}, and ΔT_{BF}_{_{Nom}} at the same rail pressures. Thus, for example, at 300 bars of pressure ΔT_{BF}_{_{Ind}}=0.750 ms, at 600 bars of pressure ΔT_{BF}_{_{Ind}}=0.321 ms, and at 1400 bars of pressure ΔT_{BF}_{_{Ind}}=0.216 ms. Thus, it can be seen that the values ΔT_{BF_Ind} for the example injector with a high opening rate shape slope are less than the values of ΔT_{BF_Nom} at corresponding operating pressures.

A curve 664 depicts the commanded on times for each of the plurality of curves (651, 652, 653, 654, 655, 656, 657, and 658) that will provide injected quantities corresponding to the optimal injected quantities and values generally corresponding of ΔT_{BF}_{_{Nom}} of graph 400 and graph 500. Thus, curve 662 defines preferred or optimal commanded on times and respective injection quantities that can be utilized in determining an injector opening rate shape slope. It shall be appreciated that injector opening rate shape slopes can be determined at values varying from those of curve 662, provided that the resulting degree of variation from the optimized robustness, accuracy, and precision provide by curve 662 is deemed acceptable for a given embodiment or control purpose. It shall be further appreciated that the shape of curve 662 varies from the shape of curve 660 reflecting differences in the operation of the individual injector from the nominal injector.

As noted above, the opening rate shape slope,

$${( \frac{\partial {Q}_{IOR}}{\partial t} )}_{Nom}$$

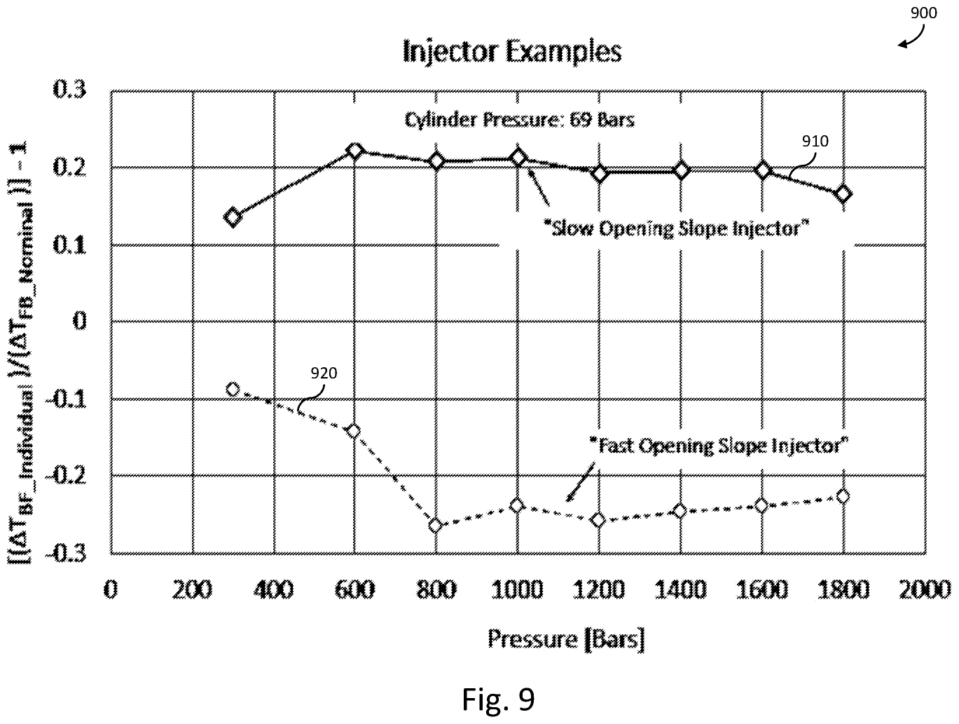

for a nominal injector may be obtained and is represented as a function of the operating pressure as in shown graph 700 in FIG. 7 for an example nominal injector configuration and design. Graph 800 of FIG. 8 illustrates the relationship between the ratio R_{Changes} in the change in injector opening slope to the change in ΔT_{BF} as a function of injector rail pressure which, as noted above, is fixed for an example embodiment injector configuration and is non-adapting in the control structure and can be obtained from injector testing or simulation. Graph 900 of FIG. 9, illustrates a curve 910 depicting the relationship between the ratio R_{Changes} and pressure for a slow opening rate shape injector which has a ΔT_{BF} value greater than that of a nominal injector and has an opening rate shape slope value that is less than that of the nominal injector. Curve 920 depicts the relationship between the ratio R_{Changes} and pressure for a fast opening rate shape injector which has a ΔT_{BF} value less than that of a nominal injector and has an opening rate shape slope value that is greater than that of the nominal injector.

As illustrated by this detailed description the present disclosure contemplates a plurality of embodiments. A first example embodiment is a method comprising: operating an individual injector of a fuel injection system to perform a fuel injection; determining an estimate of the actual injected quantity of the fuel injection; determining an on time control parameter of the individual injector in response to the estimate of the actual injected quantity and a commanded injection quantity; determining an injector opening rate shape slope estimate for the individual injector in response to the on time control parameter of the individual injector; and performing a fuel injection system control operation in response to the injector opening rate shape slope estimate for the individual injector.

A second example embodiment includes the features of the first example embodiment, wherein the on time control parameter of the individual injector comprises a change in a commanded on time to achieve an injected quantity relative to the commanded on time required to initiate injection of the individual injector.

A third example embodiment includes the features of the first example embodiment, wherein the performing the fuel injection system control operation comprises outputting a diagnostic or prognostic of the system in response to the injector opening rate shape slope estimate for the individual injector.

A fourth example embodiment includes the features of the third example embodiment, wherein the diagnostic or prognostic is determined based on a difference between the injector opening rate shape slope estimate for the individual injector and a reference valuc.

A fifth example embodiment includes the features of the fourth example embodiment, wherein the reference value comprises one of an injector opening rate shape slope estimate for a nominal injector and a previously determined value of the injector opening rate shape slope estimate for the individual injector.

A sixth example embodiment includes the features of the first example embodiment, wherein the performing the fuel injection system control operation comprises adjusting one or more injection control parameters in response to the injector opening rate shape slope estimate for the individual injector.

A seventh example embodiment includes the features of the sixth example embodiment, wherein the one or more injection control parameters comprise one or more response surfaces configured to provide one or more values of the one or more injector control parameters in response to a fueling command.

An eighth example embodiment includes the features of the sixth example embodiment, wherein the one or more injector control parameters comprise one or more of an injector on time, a rail pressure, and a start of injection timing.

A ninth example embodiment includes the features of the first example embodiment, wherein the performing the fuel injection system control operation comprises adjusting an injector monitoring operation in response to the injector opening rate shape slope estimate for the individual injector.

A tenth example embodiment includes the features of the first example embodiment, wherein the adjusting the injector monitoring operation comprises increasing a rate or frequency of monitoring.

An eleventh example embodiment is a system comprising: a fuel injection system; and an electronic control system in operative communication with the fuel injection system and configured to: operate an individual injector of a fuel injection system to perform a fuel injection; determine an estimate of the actual injected quantity of the fuel injection; determine an on time control parameter of the individual injector in response to the estimate of the actual injected quantity and a commanded injection quantity; determine an injector opening rate shape slope estimate for the individual injector in response to the on time control parameter of the individual injector; and perform a fuel injection system control operation in response to the injector opening rate shape slope estimate for the individual injector.

A twelfth example embodiment includes the features of the eleventh example embodiment, wherein the on time control parameter of the individual injector comprises a change in a commanded on time to achieve an injected quantity relative to the commanded on time required to initiate injection of the individual injector.

A thirteenth example embodiment includes the features of the eleventh example embodiment, wherein the fuel injection system control operation comprises a diagnostic or prognostic of the system performed in response to the injector opening rate shape slope estimate for the individual injector.

A fourteenth example embodiment includes the features of the thirteenth example embodiment, wherein the diagnostic or prognostic is determined based on a difference between the injector opening rate shape slope estimate for the individual injector and a reference valuc.

A fifteenth example embodiment includes the features of the fourteenth example embodiment, wherein the reference value comprises one of an injector opening rate shape slope estimate for a nominal injector and a previously determined value of the injector opening rate shape slope estimate for the individual injector.

A sixteenth example embodiment includes the features of the eleventh example embodiment, wherein the fuel injection system control operation comprises an adjustment of one or more injection control parameters in response to the injector opening rate shape slope estimate for the individual injector.

A seventeenth example embodiment includes the features of the sixteenth example embodiment, wherein the one or more injection control parameters comprise one or more response surfaces configured to provide one or more values of the one or more injector control parameters in response to a fueling command.

An eighteenth example embodiment includes the features of the sixteenth example embodiment, wherein the one or more injector control parameters comprise one or more of an injector on time, a rail pressure, and a start of injection timing.

A nineteenth example embodiment includes the features of the eleventh example embodiment, wherein the fuel injection system control operation comprises an adjustment of an injector monitoring operation in response to the injector opening rate shape slope estimate for the individual injector.

A twentieth example embodiment includes the features of the nineteenth example embodiment, wherein the adjustment of the injector monitoring operation comprises increasing a rate or frequency of monitoring.

A twenty-first example embodiment is a method comprising: operating a fuel injector to perform a fuel injection; determining an estimated actual injected quantity of the fuel injection; and determining an injector opening rate shape slope estimate for an individual injector based on the actual injected quantity of the fuel injection.

A twenty-second example embodiment includes the features of the twenty-first example embodiment and comprises controlling operation of the fuel injector to perform a subsequent fuel injection in response to the injector opening rate shape slope estimate.

A twenty-third example embodiment includes the features of the twenty-first example embodiment and comprises: diagnosing operation of the fuel injector in response to the injector opening rate shape slope estimate.

A twenty-fourth example embodiment is a method comprising: one or more non-transitory memory media configured to store instructions executable by a controller to perform the acts of: operating a fuel injector to perform a fuel injection; determining an estimated actual injected quantity of the fuel injection; and determining an injector opening rate shape slope estimate for an individual injector based on the actual injected quantity of the fuel injection.

A twenty-fifth example embodiment includes the features of the twenty-fourth example embodiment, wherein the instructions are further executable by a controller to perform the act of controlling operation of the fuel injector to perform a subsequent fuel injection in response to the injector opening rate shape slope estimate.

A twenty-sixth example embodiment includes the features of the twenty-fourth example embodiment, wherein the instructions are further executable by a controller to perform the act of diagnosing operation of the fuel injector in response to the injector opening rate shape slope estimate.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method comprising:
operating an individual injector of a fuel injection system to perform a fuel injection;
determining an estimate of the actual injected quantity of the fuel injection;
determining an on time control parameter of the individual injector in response to the estimate of the actual injected quantity and a commanded injection quantity;
determining an injector opening rate shape slope estimate for the individual injector in response to the on time control parameter of the individual injector; and
performing a fuel injection system control operation in response to the injector opening rate shape slope estimate for the individual injector.

2. The method of claim 1, wherein the on time control parameter of the individual injector comprises a change in a commanded on time to achieve an injected quantity relative to the commanded on time required to initiate injection of the individual injector.

3. The method of claim 1, wherein the performing the fuel injection system control operation comprises outputting a diagnostic or prognostic of the system in response to the injector opening rate shape slope estimate for the individual injector.

4. The method of claim 3, wherein the diagnostic or prognostic is determined based on a difference between the injector opening rate shape slope estimate for the individual injector and a reference value.

5. The method of claim 4, wherein the reference value comprises one of an injector opening rate shape slope estimate for a nominal injector and a previously determined value of the injector opening rate shape slope estimate for the individual injector.

6. The method of claim 1, wherein the performing the fuel injection system control operation comprises adjusting one or more injection control parameters in response to the injector opening rate shape slope estimate for the individual injector.

7. The method of claim 6, wherein the one or more injection control parameters comprise one or more response surfaces configured to provide one or more values of the one or more injector control parameters in response to a fueling command.

8. The method of claim 6, wherein the one or more injector control parameters comprise one or more of an injector on time, a rail pressure, and a start of injection timing.

9. The method of claim 1, wherein the performing the fuel injection system control operation comprises adjusting an injector monitoring operation in response to the injector opening rate shape slope estimate for the individual injector.

10. The method of claim 9, wherein the adjusting the injector monitoring operation comprises increasing a rate or frequency of monitoring.

11. A system comprising:
a fuel injection system; and
an electronic control system in operative communication with the fuel injection system and configured to:
operate an individual injector of a fuel injection system to perform a fuel injection;
determine an estimate of the actual injected quantity of the fuel injection;
determine an on time control parameter of the individual injector in response to the estimate of the actual injected quantity and a commanded injection quantity;
determine an injector opening rate shape slope estimate for the individual injector in response to the on time control parameter of the individual injector; and
perform a fuel injection system control operation in response to the injector opening rate shape slope estimate for the individual injector.

12. The system of claim 11, wherein the on time control parameter of the individual injector comprises a change in a commanded on time to achieve an injected quantity relative to the commanded on time required to initiate injection of the individual injector.

13. The system of claim 11, wherein the fuel injection system control operation comprises a diagnostic or prognostic of the system performed in response to the injector opening rate shape slope estimate for the individual injector.

14. The system of claim 13, wherein the diagnostic or prognostic is determined based on a difference between the injector opening rate shape slope estimate for the individual injector and a reference value.

15. The system of claim 14, wherein the reference value comprises one of an injector opening rate shape slope estimate for a nominal injector and a previously determined value of the injector opening rate shape slope estimate for the individual injector.

16. The system of claim 11, wherein the fuel injection system control operation comprises an adjustment of one or more injection control parameters in response to the injector opening rate shape slope estimate for the individual injector.

17. The system of claim 16, wherein the one or more injection control parameters comprise one or more response surfaces configured to provide one or more values of the one or more injector control parameters in response to a fueling command.

18. The system of claim 16, wherein the one or more injector control parameters comprise one or more of an injector on time, a rail pressure, and a start of injection timing.

19. The system of claim 11, wherein the fuel injection system control operation comprises an adjustment of an injector monitoring operation in response to the injector opening rate shape slope estimate for the individual injector.

20. The system of claim 19, wherein the adjustment of the injector monitoring operation comprises increasing a rate or frequency of monitoring.

21. A method comprising:
operating a fuel injector to perform a fuel injection;
determining an estimated actual injected quantity of the fuel injection; and
determining an injector opening rate shape slope estimate for an individual injector based on the actual injected quantity of the fuel injection.

22. The method of claim 21 comprising:
controlling operation of the fuel injector to perform a subsequent fuel injection in response to the injector opening rate shape slope estimate.

23. The method of claim 21 comprising:
diagnosing operation of the fuel injector in response to the injector opening rate shape slope estimate.

24. An apparatus comprising:
one or more non-transitory memory media configured to store instructions executable by a controller to perform the acts of:
operating a fuel injector to perform a fuel injection;
determining an estimated actual injected quantity of the fuel injection; and
determining an injector opening rate shape slope estimate for an individual injector based on the actual injected quantity of the fuel injection.

25. The apparatus of claim 24, wherein the instructions are further executable by a controller to perform the act of controlling operation of the fuel injector to perform a subsequent fuel injection in response to the injector opening rate shape slope estimate.

26. The apparatus of claim 24, wherein the instructions are further executable by a controller to perform the act of diagnosing operation of the fuel injector in response to the injector opening rate shape slope estimate.
